(19) United States
(12) Patent Application Publication
(10) Pub. No.: US 2024/0094241 A1
(43) Pub. Date: Mar. 21, 2024

(54) HIGH-FREQUENCY ENHANCED ELECTROCHEMICAL STRAIN MICROSCOPE AND HIGH-FREQUENCY ENHANCED ELECTROCHEMICAL STRAIN MICROSCOPY USING THE SAME

(71) Applicant: TOHOKU UNIVERSITY, Sendai-shi, Miyagi (JP)

(72) Inventor: Yoshiomi HIRANAGA, Sendai-shi (JP)

(21) Appl. No.: 18/267,281

(22) PCT Filed: Dec. 25, 2020
(86) PCT No.: PCT/JP2020/048856

§ 371 Date: Jun. 14, 2023

(51) Int. Cl. G01Q 60/30; G01Q 60/32; G01Q 60/40

(52) U.S. Cl. CPC G01Q 60/30; G01Q 60/32; G01Q 60/40

(57) ABSTRACT

A high-frequency enhanced electrochemical strain microscope (ESM) according to the present invention is configured to map an amount of local ESM response generated by applying a first AC voltage to a surface of a sample with a tip portion of a probe brought into contact with the surface of the sample. The high-frequency enhanced electrochemical strain microscope includes an AC voltage source configured to apply a second AC voltage to be superimposed on the first AC voltage and having a frequency higher than a frequency of the first AC voltage.

### TECHNICAL FIELD

The present invention relates to a high-frequency enhanced electrochemical strain microscope and high-frequency enhanced electrochemical strain microscopy using the same.

### BACKGROUND ART

In research fields of devices that utilize ionic conduction, such as lithium ion batteries (including rechargeable batteries) and oxygen sensors, electrochemical strain microscopy (ESM) is known as a technique for nanoscale probing of the motion state of ions (ion electric field response behavior, ion response in a fluctuating electric field) in a solid material, more specifically, properties such as ion mobility and ionic conductivity (Patent Document 1). ESM is a method of detecting a signal of a local volume change (electrochemical strain) in a solid caused by the motion of ions in the solid induced by voltage application, creating an image from the detected signal, and outputting the image.

Although an image showing a distribution of the motion state of ions is obtained by using ESM, a sharpness (signal-to-noise ratio) of the image depends on the ionic conductivity of the solid material. Therefore, for a solid material having a relatively low ionic conductivity, an image with sufficient sharpness (signal-to-noise ratio) cannot be obtained, and it is difficult to evaluate the motion state of the ions with high accuracy. For a solid material having extremely low ionic conductivity to the extent that the material cannot be used as an ion conductor, or for insulating materials, even creating an image is considered difficult.

### CITATION LIST

### Patent Literature

Patent Document 1: JP 2014-502354 T

### SUMMARY OF INVENTION

### Technical Problem

The present invention has been made in view of the above circumstances, and an object thereof is to provide an electrochemical strain microscope that makes it possible to evaluate a motion state of ions present in any given solid with high accuracy, and electrochemical strain microscopy using the same.

### Solution to Problem

To solve the problems described above, the present invention adopts the following means.

(1) A high-frequency enhanced electrochemical strain microscope (ESM) according to an aspect of the present invention is configured to map an amount of local ESM response generated by applying a first AC voltage to a surface of a sample with a tip portion of a probe brought into contact with the surface of the sample. The high-frequency enhanced electrochemical strain microscope includes an AC voltage source configured to apply a second AC voltage to be superimposed on the first AC voltage and having a frequency higher than a frequency of the first AC voltage.

(2) In the high-frequency enhanced electrochemical strain microscope according to (1) described above, the frequency of the second AC voltage is preferably from two times to 10¹⁶ times the frequency of the first AC voltage.

(3) In the high-frequency enhanced electrochemical strain microscope according to (1) or (2) described above, the frequency of the second AC voltage is preferably from 1 MHz to 10 THz.

(4) In the high-frequency enhanced electrochemical strain microscope according to any one of (1) to (3) described above, the frequency of the first AC voltage is preferably from 1 mHz to 10 MHz.

(5) High-frequency enhanced electrochemical strain microscopy according to an aspect of the present invention is microscopy for mapping an amount of ESM response at a surface of a sample by using an electrochemical strain microscope (ESM) configured to map an amount of local ESM response generated by applying a first AC voltage to the surface of the sample with a tip portion of a probe brought into contact with the surface of the sample. The high-frequency enhanced electrochemical strain microscopy includes, in the mapping, superimposing a second AC voltage on the first AC voltage, the second AC voltage having a frequency higher than a frequency of the first AC voltage.

(6) In the high-frequency enhanced electrochemical strain microscopy according to (5) described above, the sample is preferably an ion conductor.

(7) In the high-frequency enhanced electrochemical strain microscopy according to (5) described above, the sample is preferably an insulator.

### Advantageous Effects of Invention

According to the present invention, it is possible to provide a high-frequency enhanced electrochemical strain microscope that makes it possible to evaluate a motion state of ions present in any given solid with high accuracy, and high-frequency enhanced electrochemical strain microscopy using the same.

### BRIEF DESCRIPTION OF DRAWINGS

FIG. 1 is a configuration diagram of a high-frequency enhanced electrochemical strain microscope according to an embodiment of the present invention.

FIG. 2A is an image of a sample surface in Comparative Example 1.

FIG. 2B is an image of a sample surface in Example 1.

FIG. 2C is an image of a sample surface in Example 2.

FIG. 3 is a graph showing profiles of strain rates of the samples in Comparative Example 1 and Example 1.

FIG. 4 is a graph showing dependencies of signal intensities of the samples on the frequency of the first AC voltage in Comparative Example 1 and Example 1.

FIG. 5A is an image of a sample surface in Reference Example.

FIG. 5B is an image of a sample surface in Comparative Example 2.

FIG. 5C is an image of a sample surface in Example 3.

FIG. 6 is a graph showing profiles of response signals of samples in Comparative Example 2 and Example 3.

### DESCRIPTION OF EMBODIMENTS

Hereinafter, a high-frequency enhanced electrochemical strain microscope and high-frequency enhanced electrochemical strain microscopy according to an embodiment to which the present invention is applied will be described in detail with reference to the drawings. Note that, in the drawings referenced in the following description, characteristic portions may be enlarged as necessary to facilitate understanding of features, and the dimensional ratios and the like of the respective components are not necessarily to actual scale. Further, the materials, dimensions, and the like in the following description are merely exemplary and are not intended to limit the present invention, and can be appropriately modified within a range not departing from the scope of the present invention.

### High-Frequency Enhanced Electrochemical Strain Microscope

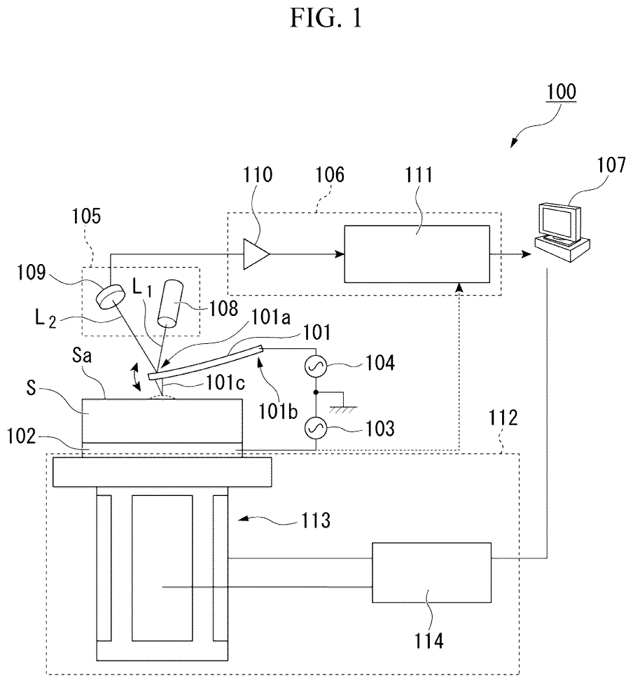

FIG. 1 is a drawing schematically illustrating a configuration of a high-frequency enhanced electrochemical strain microscope (ESM) 100 according to an embodiment of the present invention, configured to map an amount of local ESM response generated by applying a first AC voltage to a surface of a solid sample S with a tip portion of a probe brought into contact with the surface of the solid sample S. The ESM response amount refers to an amount of local displacement or the like, or an amount of change accompanying the displacement or the like, in the sample S measured by the electrochemical strain microscope 100. Hereinafter, the high-frequency enhanced electrochemical strain microscope 100 of the present embodiment may be referred to as an “electrochemical strain microscope 100.”

The electrochemical strain microscope 100 mainly includes a cantilever 101, an electrode member 102, two AC power supplies (a first AC power supply 103 and a second AC power supply 104), a signal detection unit 105, and a signal output unit 106. The sample S is not particularly limited to any material, and is preferably an ion conductor, but may also be a material having low ionic conductivity, or an insulating material.

The cantilever 101 includes a free end 101a including a probe (probe tip portion) 101c that is brought into contact with or close to an observed surface (surface) Sa of the sample S, and a fixed end 101b electrically connected to the first AC power supply 103 and the second AC power supply 104. The cantilever 101 functions as one electrode (upper electrode) when a voltage is applied to the sample S. As the cantilever 101, a cantilever obtained by coating a surface of a base material made of silicon, silicon nitride, or the like with a metal can be used. Examples of the metal for coating the surface of the base material include platinum, platinum-iridium, gold, and rhodium. The surface coating material is not limited to a metal and may be, for example, conductive diamond. Surface coating is not necessary if the base material has sufficient conductivity, such as when sufficiently highly doped silicon is used for the base material or when a metal is used for the base material.

The electrode member 102 supports the sample S and is electrically connected to the cantilever 101 via the first AC power supply 103 and the second AC power supply 104, functioning as another electrode (lower electrode) that forms a pair with the cantilever 101. A material of the electrode member 102 is preferably platinum or gold from the viewpoint of chemical stability, but is not particularly limited as long as a material having conductivity, such as a metal, is used. For example, aluminum, chromium, or silver may be used.

The first AC power supply 103 has a function of applying a predetermined first AC voltage (low-frequency voltage) via the cantilever 101 and the electrode member 102 to the sample S interposed between the cantilever 101 and the electrode member 102, and controlling a motion state (transport state) of ions in the sample S. A frequency of the first AC voltage needs to be large enough for the ions in the sample S to react to the frequency and oscillate, and is preferably, for example, about from 1 mHz to 10 MHz. From the viewpoint of increasing a signal-to-noise (S/N) ratio of a response signal, the frequency is more preferably about from 1 mHz to 10 kHz. From the viewpoint of shortening observation time, the frequency is more preferably about from 1 kHz to 10 MHz. An amplitude of the first AC voltage needs to be large enough to induce electrochemical re-distribution of the ions in the sample S. For example, the amplitude is preferably about from 1 m Vₚₖ to 10 Vₚₖ, and more preferably about from 0.1 to 2 Vₚₖ from the viewpoint of obtaining a clear observation image while reducing irreversible effects on the measurement target (Vₚₖ refers to peak voltage).

The second AC power supply 104 applies a second AC voltage (high-frequency voltage) via the cantilever 101 and the electrode member 102 to the sample S interposed between the cantilever 101 and the electrode member 102. The second AC voltage is superimposed on the first AC voltage and has a frequency higher than the frequency of the first AC voltage. Further, the second AC power supply 104 has a function of increasing ease of movement (mobility) of the ions in the sample S, thereby enhancing (amplifying) a response signal proportional to the product of the ease of movement of the ions and the amplitude of the first AC voltage. The frequency of the second AC voltage is preferably about from 1 MHz to 10 THz, and more preferably about from 100 MHz to 10 GHz. An upper limit of a frequency range of so-called “ionic polarization” in dielectric dispersion is about 10 THz, and therefore the enhancement effect is likely to occur when the frequency is 10 THz or less. In a frequency band exceeding 10 THz, that is, in a region of electronic polarization (optical region), ions in a crystal cannot follow the fluctuating electric field, and thus the enhancement effect is unlikely to occur. An amplitude of the second AC voltage is not limited, and an amplitude in a range from about 1 to 5 Vₚₖ in a case of a microwave voltage in particular achieves in particular a remarkable effect of enhancing the response signal.

FIG. 1 illustrates a case in which the first AC power supply 103 is inserted (connected) between the electrode member 102 and a ground point and applies the first AC voltage to the sample S via the electrode member 102. Simultaneously, the second AC power supply 104 is inserted (connected) between the cantilever 101 and a ground point and applies the second AC voltage to the sample S via the cantilever 101. However, the first AC power supply 103 and the second AC power supply 104 may be switched. Further, although FIG. 1 illustrates a case in which the first AC voltage and the second AC voltage are applied from separate AC power supplies, the first AC voltage and the second AC voltage may be added together by an adder circuit using an operational amplifier or the like, and the added AC voltage may be applied from one AC power supply. As a means for adding the first AC voltage 103 and the second AC voltage 104, a passive circuit such as an inductance-capacitance-resistance (LCR) circuit designed with a predetermined pass frequency band may be used without using an active element such as an operational amplifier.

The frequency of the second AC voltage is preferably from two times to 10¹⁶ times the frequency of the first AC voltage. When the multiplication factor of the frequency of the second AC voltage with respect to that of the first AC voltage is less than two, neither the enhancement function obtained by a thermal effect depending on dielectric loss of the material nor the enhancement function obtained by a non-thermal effect (electromagnetic effect) depending on a dielectric constant of the material is sufficiently obtained. When the frequency of the second AC voltage exceeds 10 THz, the motion of ions cannot follow the high-frequency electric field, and thus the enhancement function cannot be obtained. An upper limit value of the multiplication factor of the frequency of the second AC voltage with respect to that of the first AC voltage is not limited, in principle. However, in consideration of a frequency range that can be practically selected for the frequency of the first AC voltage and the limitation that the frequency of the second AC voltage cannot exceed 10 THz, the practical upper limit of the multiplication factor is about 10¹⁶.

The multiplication factor of the frequency of the second AC voltage with respect to that of the first AC voltage is more preferably about from 10² times to 10⁹ times, and more preferably about from 10³ times to 10⁷ times.

The signal detection unit 105 mainly includes a light source (laser element) 108 that irradiates the cantilever 101 with laser light L₁ and an optical sensor (photodiode, split photodetector, or the like) 109 that detects reflected light L₂ including a contribution of the ESM response from the cantilever 101. The light source 108 is disposed so that the laser light L₁ can be emitted to a back surface of the cantilever 101 on the free end 101a side (surface on the side opposite to the probe 101c). The optical sensor 109 is fixed at one location so that at least some of the reflected light L₂ from the free end 101a of the cantilever 101 reaches the optical sensor 109.

In the present embodiment, an optical lever type unit is used as the signal detection unit 105, but the signal detection unit 105 is not limited thereto, and a unit that detects bending (displacement, vibration, or the like) of the cantilever (a laser interference type unit or a self-detection type unit, for example) may be used. A laser interference type signal detection unit (not illustrated) detects the strain of the cantilever by using a laser interferometer. A self-detection type signal detection unit (not illustrated) detects the strain of the cantilever by using a strain sensor mounted on the cantilever 101.

The signal output unit 106 mainly includes a preamplifier 110 and a lock-in amplifier 111, and is electrically connected to the first AC voltage supply 103. In the signal output unit 106, the preamplifier 110 amplifies the ESM response signal detected by the signal detection unit 105, and then the lock-in amplifier 111 using a reference signal synchronized with the first AC voltage removes a noise signal. The resulting signal is output from the signal output unit 106 to a predetermined image display unit 107 or the like.

In the most basic configuration, a voltage with a sine wave form is used as the first AC voltage and the response in this case is detected by the lock-in amplifier 111. However, a configuration in which the first AC voltage with a non-sine wave form is applied to the sample S and the response in this case is detected by a method other than using the lock-in amplifier may also be adopted. In a method called band excitation, a bias with a waveform having, in the frequency spectrum, a spectrum with a certain width near the resonant frequency of the cantilever is applied to a sample, and the response waveform is then analyzed by using fast Fourier transform (FFT). This technique may also be employed.

A sample moving unit 112 mainly includes a positioning stage (piezo scanner) 113 and a control device 114 for the positioning stage 113, and has a function of changing a relative positional relationship between the probe 101c of the cantilever 101 and an observed portion on the sample surface Sa. With this function, the probe 101c of the cantilever 101 can be moved on (swept across) the sample surface Sa. Note that the probe 101c itself of the cantilever 101 may be moved relative to the observed portion of the sample S without using the sample moving unit 112.

### Electrochemical Strain Microscopy

The electrochemical strain microscopy for mapping the amount of ESM response at the surface of the sample S by using the electrochemical strain microscope 100 having the configuration described above mainly includes the following steps.

First, the sample S is placed on the electrode member 102, and the first AC voltage and the second AC voltage are applied between the cantilever 101 and the electrode member 102 under the conditions described above with the probe 101c of the cantilever 101 brought into contact with or close to the sample surface (observed surface) Sa (voltage application step).

The volume of the sample S locally changes in accordance with the motion state of the ions induced by application of the first AC voltage. Accordingly, a portion of the observed surface Sa is locally displaced with respect to other portions, and a bending amount of the cantilever 101 in contact with or close to the displaced portion changes compared to a state in which the first AC voltage is not applied. In the present embodiment, this bending amount corresponds to the ESM response amount described above.

The bending amount of the cantilever 101 is proportional to the displacement amount of the observed surface Sa of the sample. When the cantilever 101 bends, a reflection angle of the reflected light L₂ changes, and the value of a difference signal detected by the split photodiode included in the sensor 109 changes. From this difference signal, the displacement amount of the surface of the sample S can be estimated, and the motion state of the ions causing the displacement can be detected. The motion state of the ions and the displacement of the observed surface Sa associated therewith change on the basis of the frequency of the first AC voltage. Accordingly, the bending amount of the cantilever 101 is detected as a response signal that oscillates at a predetermined frequency (signal detection step).

The response signal detected by the signal detection unit 105 is amplified by the preamplifier 110, the noise signal is removed by the lock-in amplifier 111 using the reference signal synchronized with the first AC voltage, and the resulting signal is output to the predetermined image display unit 107 or the like (signal output step). From the output image, the motion state of the ions in the sample S can be evaluated.

In the electrochemical strain microscope 100 of the present embodiment, the second AC voltage having a frequency higher than that of the first AC voltage is applied in addition to the first AC voltage that controls the motion state of the ions contained in any given material (sample S). Thus, the response signal generated in accordance with the motion state of the ions can be dramatically enhanced, resulting in a large intensity difference between the response signals generated in different motion states. As a result, the distribution of the motion state of the ions in the sample S can be clearly shown as an image or numerical data, and thus can be evaluated with high accuracy. Note that, in a case in which the first AC voltage on the low frequency side is not applied, the response signal is not generated and the response signal intensity is zero. Accordingly, the response signal intensity remains zero even though the second AC voltage on the high frequency side is applied thereto.

The electrochemical strain microscope 100 of the present embodiment can also be applied to materials considered difficult to evaluate with a conventional electrochemical strain microscope, such as a material having a low ionic conductivity or an insulating material (insulator) not generally called an ion conductor, and this makes it possible to evaluate physical properties of various materials with unprecedented high accuracy.

On the other hand, for a material having a high ionic conductivity that can be evaluated by a conventional electrochemical strain microscope, because of the enhancement function by the second AC voltage, an image suitable for evaluation can be output even if the first AC voltage is lowered. With this configuration, it is also possible to reduce damage to the sample caused by application of the first AC voltage.

### EXAMPLES

Hereinafter, the advantageous effects of the present invention will be made more apparent by examples. Note that the present invention is not limited to the following examples, and can be carried out with appropriate modifications without departing from the scope of the invention.

### Comparative Example 1

An electrode member (silver) of the electrochemical strain microscope described above was bonded (attached with a silver paste) to one surface (lower surface) of a sample made of LiTaO₃ and having a flat shape. With a configuration in which the second AC voltage was not applied (a conventional electrochemical strain microscope), a response signal caused by the motion state of the ions was detected as in the electrochemical strain microscopy (high-frequency enhanced electrochemical strain microscopy) of the present invention. The observed surface (main surface) of the sample had an area of 8 μm² and a thickness of 500 μm. As the cantilever (upper electrode member), a cantilever obtained by coating the surface of a material with platinum-iridium was used. A first AC voltage of 10 kHz and 0.5 Vₚₖ was applied to the sample from the first AC power supply.

### Example 1

The same sample as in Comparative Example 1 was placed on the electrode member of the electrochemical strain microscope described above, and a response signal caused by the motion state of the ions was detected in accordance with electrochemical strain microscopy. The cantilever and the lower electrode member used were made of the same materials as in Comparative Example 1. As illustrated in FIG. 1, the first AC power supply was inserted (connected) between the electrode member and the ground point, and the second AC power supply was inserted (connected) between the cantilever and the ground point. A first AC voltage of 10 kHz and 0.5 Vₚₖ was applied from the first AC power supply, and a second AC voltage of 1 GHz was applied from the second AC power supply to the sample.

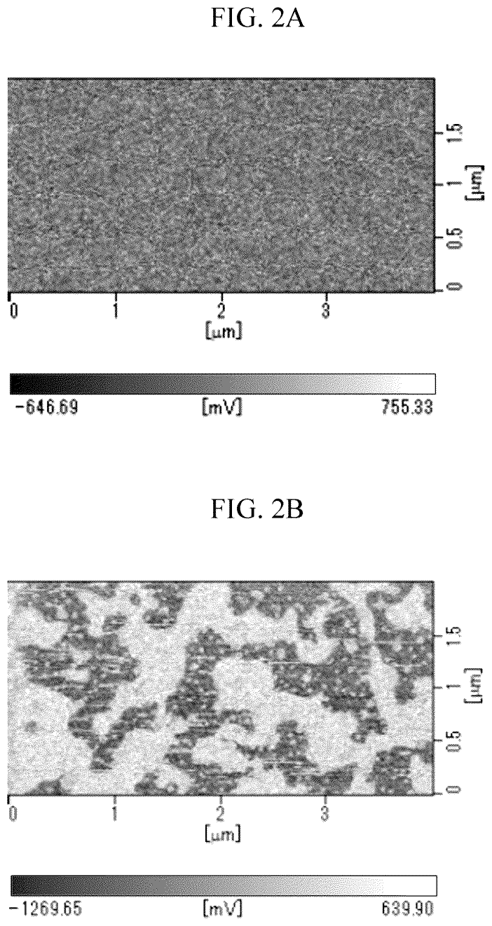

In each of Comparative Example 1 and Example 1, the same location of the sample was observed. FIGS. 2A and 2B are images of the same locations of the samples detected in Comparative Example 1 and Example 1, respectively. While nothing is identifiable from the image of Comparative Example 1 corresponding to a conventional configuration, the distribution of ionic conduction can be clearly identified from the image of Example 1 obtained by applying the high-frequency second AC voltage. Relatively, a brighter portion indicates higher ionic conduction, and a darker portion indicates lower ionic conduction. From these results, it can be seen that the distribution of the motion state of ions, which could not be detected in the related art, can be detected by applying the second AC voltage.

### Example 2

Using a sample and an electrochemical strain microscope having the same configurations as in Example 1, a response signal caused by the motion state of ions was detected in accordance with electrochemical strain microscopy. However, while the observation region was moved in one direction, the frequency of the second AC voltage to be applied was changed in the order of no application, 100 kHz, 300 kHz, 1 MHz, 3 MHz, 10 MHz, 30 MHz, and 100 MHz.

FIG. 2C is an image of the sample surface detected in Example 2. While nothing is identifiable in the region where the second AC voltage was not applied, the distribution of the motion state of the ions can be identified in the region (from 100 kHz to 100 MHz) where the second AC voltage was applied. The image increases in sharpness as the frequency of the applied second AC voltage increases. In particular, the change in sharpness (resolution) between the 30 MHz region and the 100 MHz region is remarkable. From this result, it can be seen that a degree of enhancement (sharpness of acquired image) by application of the second AC voltage depends on the frequency of the second AC voltage.

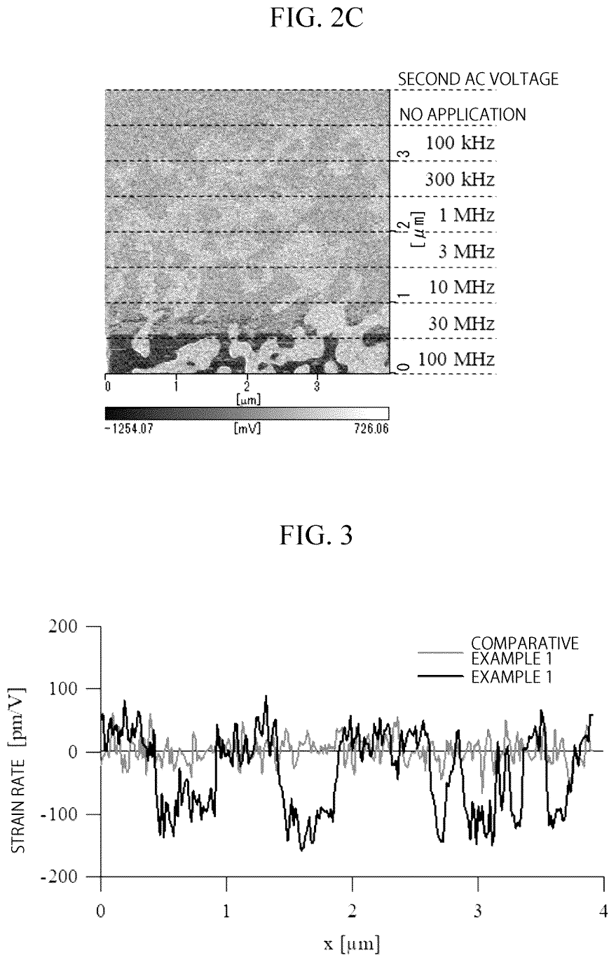

FIG. 3 is a graph showing profiles of response signals detected from the samples in Comparative Example 1 and Example 1. The horizontal axis of the graph represents an observation position×(μm) on the sample surface, and the vertical axis of the graph represents a strain amount (hereinafter referred to as “strain rate”) (pm/V) of the sample surface per 1 V of the first AC voltage. In Comparative Example 1, the strain rate is substantially uniform (approximately 0 pm/V) within a range of 4 μm, and the distribution of the motion state of the ions is not identifiable from this. On the other hand, in Example 1, although the sample has the same configuration as that of Comparative Example 1, the strain rate intensely fluctuates in the range of 4 μm in correspondence with the distribution of the motion state of the ions, making it possible to thereby identify the distribution of the motion state of the ions. From these results, it can be seen that, with the use of the electrochemical strain microscope of the present invention, it is possible to identify and evaluate with high accuracy the distribution of the motion state of the ions by numerical data.

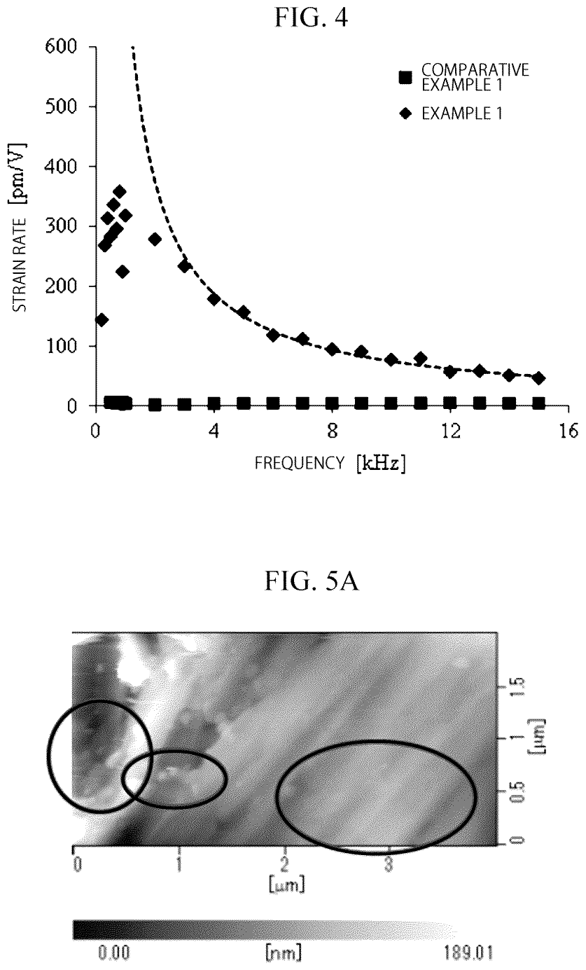

FIG. 4 is a graph showing dependencies of the strain rates of the samples on the frequency of the first AC voltage in Comparative Example 1 and Example 1. The horizontal axis of the graph represents the frequency (kHz) of the first AC voltage, and the vertical axis of the graph represents the strain rate (pm/V). In Comparative Example 1, the strain rate is substantially 0 pm/V in the frequency range of 16 kHz or less, whereas in Example 1, the strain rate is not 0 pm/V in the same range and increases as the frequency decreases. In electrochemical strain microscopy, it is known that the intensity of a signal obtained due to ionic conduction is inversely proportional to the frequency of the first AC voltage (low-frequency AC bias). In Example 1, because the strain rate corresponding to the signal intensity indicates a similar frequency dependency, it can be seen that this frequency dependency of the strain rate is caused by ionic conduction.

### Reference Example

A surface shape (surface unevenness) of a sample made of lithium lanthanum titanate La_{0.57}Li_{0.29}TiO₃ and having a flat shape (area of main surface: 8 μm², thickness: 500 μm) was observed by using an atomic force microscope.

### Comparative Example 2

The electrode member (silver) of the electrochemical strain microscope described above was bonded (attached with a silver paste) to one surface (lower surface) of the same sample as in Reference Example. With a configuration in which the second AC voltage was not applied, a response signal caused by the motion state of the ions was detected as in the electrochemical strain microscopy of the present invention. The cantilever and the lower electrode member used were made of the same materials as in Comparative Example 1. A first AC voltage of 56.1 kHz and 1 Vₚₖ was applied to the sample from the first AC power supply.

### Example 3

The electrode member (silver) of the electrochemical strain microscope described above was bonded (attached to a silver paste) to one surface (lower surface) of the same sample as in Reference Example. A response signal caused by the motion state of the ions was detected in accordance with the electrochemical strain microscopy of the present invention. The cantilever and the lower electrode member used were made of the same materials as in Comparative Example 1. As illustrated in FIG. 1, the first AC power supply was inserted (connected) between the electrode member and the ground point, and the second AC power supply was inserted (connected) between the cantilever and the ground point. A first AC voltage of 56.1 kHz and 1 Vₚₖ was applied from the first AC power supply, and a second AC voltage of 1 GHz was applied from the second AC power supply to the sample.

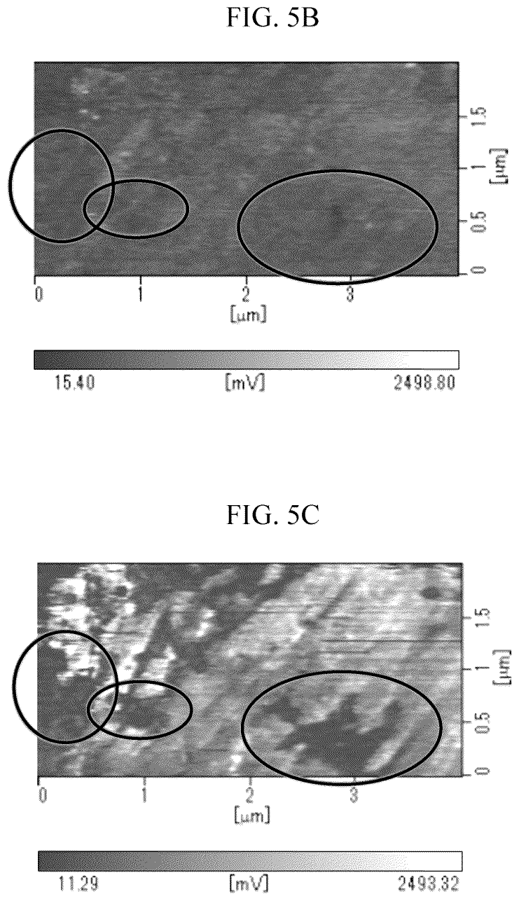

In each of Reference Example, Comparative Example 2, and Example 3, the same location of the sample was observed. FIGS. 5A to 5C are images of the same locations of the samples detected in Reference Example, Comparative Example 2, and Example 3, respectively.

In the output image of Reference Example, the uneven structure of the sample surface is apparent, with relatively brighter portions indicating protruding portions and darker portions indicating recessed portions. In the output image of Comparative Example 2 obtained by the conventional electrochemical strain microscopy, the distribution of the motion state of the ions is shown in an unclear manner. In this image, it is difficult to identify the boundaries of each distribution.

On the other hand, the distribution of the motion state of the ions can be clearly identified from the image of Example 3 in which the high-frequency second AC voltage was applied. Relatively, a brighter portion indicates larger (more intense) ionic conduction, and a darker portion indicates smaller (more moderate) ionic conduction. From comparison between the images of FIGS. 5B and 5C, it can be seen that the unclear distribution in the output image obtained by the electrochemical strain microscopy of the conventional configuration became clear by applying the second AC voltage. From comparison between the images of FIGS. 5A and 5C, it can be seen that the distribution observed in Example 3 is different from the distribution observed in Reference Example and does not indicate the uneven structure of the sample surface. From these results, it can be seen that the distribution of the motion state of the ions, which could not be detected in the related art, can be detected by applying the second AC voltage.

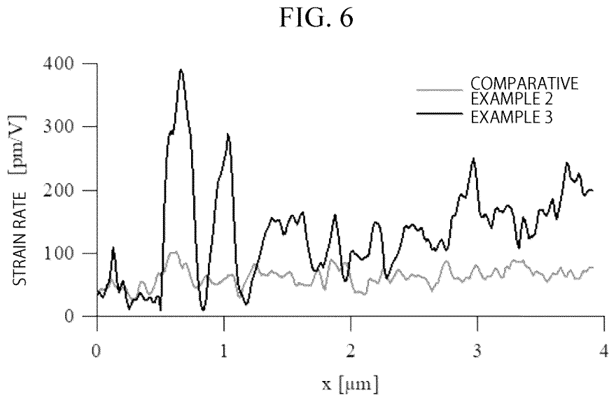

FIG. 6 is a graph showing profiles of response signals detected from the samples in Comparative Example 2 and Example 3. The horizontal axis and the vertical axis of the graph are the same as those in FIG. 3. In Comparative Example 2, the strain rate is substantially uniform (100 pm/V or less) within a range of 4 μm, and it is difficult to clearly identify the distribution of the motion state of the ions from this. On the other hand, in Example 3, although the sample has the same configuration as that of Comparative Example 2, the strain rate intensely fluctuates in the range of 4 μm in correspondence with the distribution of the motion state of the ions, making it possible to thereby identify the distribution of the motion state of the ions. From these results, it can be seen that, with the use of the electrochemical strain microscope of the present invention, it is possible to identify and evaluate with high accuracy the distribution of the motion state of the ions by numerical data.

### REFERENCE SIGNS LIST

100 Electrochemical strain microscope
101 Cantilever
102 Electrode member
103 First AC power supply
104 Second AC power supply
105 Signal detection unit
106 Signal output unit
107 Image display unit
108 Light source
109 Optical sensor
110 Preamplifier
111 Lock-in amplifier
112 Sample moving unit
113 Positioning stage
114 Control device
L₁ Laser light
L₂ Reflected light
S Sample
Sa Observed surface (surface)

1. A high-frequency enhanced electrochemical strain microscope (ESM) configured to map an amount of local ESM response generated by applying a first AC voltage to a surface of a sample with a tip portion of a probe brought into contact with the surface of the sample, the high-frequency enhanced electrochemical strain microscope comprising:
an AC voltage source configured to apply a second AC voltage to be superimposed on the first AC voltage and having a frequency higher than a frequency of the first AC voltage.

2. The high-frequency enhanced electrochemical strain microscope according to claim 1, wherein the frequency of the second AC voltage is from two times to 10¹⁶ times the frequency of the first AC voltage.

3. The high-frequency enhanced electrochemical strain microscope according to claim 1, wherein the frequency of the second AC voltage is from 1 MHz to 10 THz.

4. The high-frequency enhanced electrochemical strain microscope according to claim 1, wherein the frequency of the first AC voltage is from 1 mHz to 10 MHz.

5. High-frequency enhanced electrochemical strain microscopy for mapping an amount of ESM response at a surface of a sample by using an electrochemical strain microscope (ESM) configured to map an amount of local ESM response generated by applying a first AC voltage to the surface of the sample with a tip portion of a probe brought into contact with the surface of the sample, the high-frequency enhanced electrochemical strain microscopy comprising:
in the mapping, superimposing a second AC voltage on the first AC voltage, the second AC voltage having a frequency higher than a frequency of the first AC voltage.

6. The high-frequency enhanced electrochemical strain microscopy according to claim 5, wherein the sample is an ion conductor.

7. The high-frequency enhanced electrochemical strain microscopy according to claim 5, wherein the sample is an insulator.

8. The high-frequency enhanced electrochemical strain microscope according to claim 2, wherein the frequency of the second AC voltage is from 1 MHz to 10 THz.

9. The high-frequency enhanced electrochemical strain microscope according to claim 8, wherein the frequency of the first AC voltage is from 1 mHz to 10 MHz.

10. The high-frequency enhanced electrochemical strain microscope according to claim 2, wherein the frequency of the first AC voltage is from 1 mHz to 10 MHz.
